(19) United States
(12) Patent Application Publication
(10) Pub. No.: US 2026/0031625 A1
(43) Pub. Date: Jan. 29, 2026

(54) SPECIALLY EQUIPPED VEHICLE

(71) Applicant: TOYOTA JIDOSHA KABUSHIKI KAISHA, Toyota-shi (JP)

(72) Inventors: Tetsu TODO, Toyota-shi (JP); Tomohiro Shinagawa, Toyota-shi (JP)

(73) Assignee: TOYOTA JIDOSHA KABUSHIKI KAISHA, Toyota-shi (JP)

(21) Appl. No.: 19/066,807

(22) Filed: Feb. 28, 2025

(30) Foreign Application Priority Data
Jul. 26, 2024 (JP) 2024-121431

(51) Int. Cl. H02J 3/14; B60L 1/00

(52) U.S. Cl. CPC H02J 3/14; B60L 1/00; B60L 2200/40; H02J 2310/48

(57) ABSTRACT

In a specially equipped vehicle, a first relay is provided on the electrified vehicle side of a power supply line connecting a battery installed in an electrified vehicle and power loads (inverter and motor) provided in mounted electric equipment mounted on the electrified vehicle. A second relay is provided on the mounted electric equipment side of the power supply line. A mounted ECU provided in the mounted electric equipment turns on or off the second relay in response to an operation of an operation switch of the mounted electric equipment, and a control ECU provided in the electrified vehicle turns off the first relay when the mounted electric equipment is to be electrically disconnected from the electrified vehicle.

### CROSS-REFERENCE TO RELATED APPLICATION

This application claims priority to Japanese Patent Application No. 2024-121431 filed on Jul. 26, 2024. The disclosure of the above-identified application, including the specification, drawings, and claims, is incorporated by reference herein in its entirety.

### BACKGROUND

### 1. Technical Field

The present disclosure relates to specially equipped vehicles.

### 2. Description of Related Art

Japanese Unexamined Patent Application Publication No. 2020-66353 (JP 2020-66353 A) describes mounted equipment that is mounted on a vehicle including a vehicle-side battery and a vehicle-side electric device configured to be driven with an output voltage of the vehicle-side battery. The mounted equipment controls output of a power supply unit for the mounted equipment so as to apply an output voltage of the power supply unit for the mounted equipment to the vehicle-side electric device while the vehicle is stopped.

### SUMMARY

In a specially equipped vehicle, while mounted equipment is in operation, a power switch (ignition switch) of the vehicle may be turned on or off to connect or disconnect a battery installed in the vehicle to or from a power supply circuit. In this case, an electromotive force, back electromotive force, etc. generated at this time may damage the mounted equipment. A possible method to prevent damage to the mounted equipment is to provide a relay for turning on and off a mounted equipment-side power supply. In this method, when the power switch of the vehicle is turned on or off, a vehicle-side control unit communicates with a mounted equipment-side control unit to turn off the relay. In this case, however, the interface between the vehicle-side control unit and the mounted equipment-side control unit becomes complicated, which increases the cost required to develop programs. In addition, if a failure occurs in the mounted equipment, the power switch of the vehicle cannot be turned on, and therefore, the vehicle cannot be moved.

The present disclosure was made in view of the above circumstances, and provides a specially equipped vehicle that can, when needed, electrically disconnect mounted equipment from the vehicle by using a simple configuration.

A specially equipped vehicle according to a first aspect includes:
a first switching unit provided on a vehicle side of a power supply circuit connecting a battery installed in the vehicle and a power load provided in mounted equipment mounted on the vehicle;
a second switching unit provided on a mounted equipment side of the power supply circuit;
a mounted equipment-side control unit provided in the mounted equipment and configured to turn on or off the second switching unit in response to an operation of a switch of the mounted equipment; and
a vehicle-side control unit provided in the vehicle and configured to turn off the first switching unit when the mounted equipment is to be electrically disconnected from the vehicle.

In the first aspect, the first switching unit is provided on the vehicle side of the power supply circuit connecting the battery installed in the vehicle and the power load provided in the mounted equipment mounted on the vehicle, and the second switching unit is provided on the mounted equipment side of the power supply circuit. The mounted equipment-side control unit turns on or off the second switching unit in response to an operation of the switch of the mounted equipment, and the vehicle-side control unit turns off the first switching unit when the mounted equipment is to be electrically disconnected from the vehicle.

The mounted equipment can thus be electrically disconnected from the vehicle, when needed, by turning off the first switching unit. This configuration eliminates the need for the vehicle-side control unit to perform control to turn off the second switching unit through communication with the mounted equipment-side control unit in order to electrically disconnect the mounted equipment from the vehicle. As a result, the interface between the control units can be simplified. It is therefore possible to electrically disconnect the mounted equipment from the vehicle, when needed, by using a simple configuration, which can reduce the development cost for programs etc. to be installed in the control units.

According to a second aspect, in the first aspect, when the mounted equipment is to be electrically disconnected from the vehicle is when a power switch of the vehicle is turned on or off.

In the second aspect, when the power switch of the vehicle is turned on or off, the first switching unit is turned off to electrically disconnect the mounted equipment from the vehicle. This configuration can reduce damage to the mounted equipment when the power switch of the vehicle is turned on or off.

According to a third aspect, in the first aspect, when the mounted equipment is to be electrically disconnected from the vehicle is when the vehicle-side control unit detects a failure of the mounted equipment through communication with the mounted equipment-side control unit.

In the third aspect, when a failure of the mounted equipment is detected, the first switching unit is turned off to electrically disconnect the mounted equipment from the vehicle. Accordingly, even when a failure occurs in the mounted equipment, the power switch of the vehicle can be turned on to cause the vehicle to travel.

The present disclosure is advantageous in that it is possible to electrically disconnect the mounted equipment from the vehicle, when needed, by using a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a specially equipped vehicle according to an embodiment;

FIG. 2 is a flowchart of a first relay control process that is performed by a control ECU; and

FIG. 3 is a schematic configuration diagram of a specially equipped vehicle according to a comparative example.

### DETAILED DESCRIPTION OF EMBODIMENTS

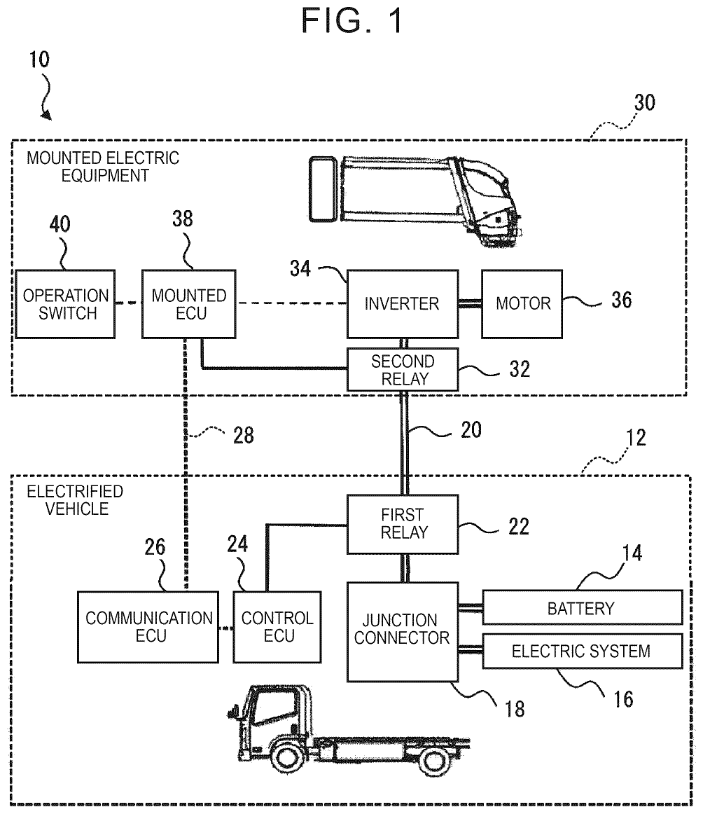

Hereinafter, an example of an embodiment of the present disclosure will be described in detail with reference to the drawings. FIG. 1 shows a specially equipped vehicle 10 according to the present embodiment. The specially equipped vehicle 10 is configured such that the mounted electric equipment 30 is mounted on the electrified vehicle 12. Although FIG. 1 shows the appearance of a dust collection and compression device that causes the specially equipped vehicle 10 to function as a dust truck as an example of the mounted electric equipment 30, the mounted electric equipment 30 is not limited to this. The specially equipped vehicle 10 is an example of the specially equipped vehicle according to the present disclosure, electrified vehicle 12 is an example of the vehicle according to the present disclosure, and the mounted electric equipment 30 is an example of the mounted equipment according to the present disclosure.

The electrified vehicle 12 is equipped with a battery 14 and an electric system 16 including a traction motor and a power control unit (PCU). The battery 14 is a high-voltage battery that is higher than an auxiliary battery, not shown, installed in the electrified vehicle 12. The battery 14 and the electric system 16 are connected via a junction connector 18. When the electrified vehicle 12 travels, the electric power stored in the battery 14 is supplied to the electric system 16, thereby driving the traction motor. Although not shown in the figures, a main relay is provided between the battery 14 and the junction connector 18.

One end of the power supply line 20 is connected to the junction connector 18, and the other end of the power supply line 20 is connected to the motor 36 via the inverter 34 of the mounted electric equipment 30. Note that the power supply line 20 is an example of a power supply circuit in the present disclosure, and the inverter 34 and the motor 36 of the mounted electric equipment 30 are an example of a power load of the mounted electric equipment 30.

For example, the mounted electric equipment 30 may be a dust collection and compression device. In this instance, the motor 36 generates a driving force for transferring and compressing the input dust into the stowage bin by electric power supplied from the battery 14 of electrified vehicle 12 via the power supply line 20. The inverter 34 is connected to the mounted ECU (Electronic Control Unit) 38, and the operation of the inverter 34 and the motor 36 is controlled by the mounted ECU 38.

A first relay 22 is provided on the electrified vehicle 12 side in the power supply line 20, and a second relay 32 is provided on the mounted electric equipment 30 side in the power supply line. The second relay 32 is connected to the mounted ECU 38. An operation switch 40 for turning on and off the power of the mounted electric equipment 30 is connected to the mounted ECU 38. The mounted ECU 38 turns on and off the second relay 32 in response to the operation of the operation switch 40. The second relay 32 is an example of the second switching unit in the present disclosure, and the mounted ECU 38 is an example of the mounted equipment-side control unit in the present disclosure.

The mounted ECU 38 is connected to a communication ECU 26 provided in electrified vehicle 12 via a communication line 28. The communication ECU 26 is also connected to an electrified vehicle 12 control ECU 24, and is capable of communicating with the mounted ECU 38 and the control ECU 24 via a communication line 28 and a communication ECU 26.

The control ECU 24 is connected to the first relay 22. The control ECU 24 turns off the first relay 22 when the mounted electric equipment 30 is to be electrically disconnected from electrified vehicle 12. When the mounted electric equipment 30 is to be electrically disconnected from electrified vehicle 12, a power switch (ignition switch), not shown, of electrified vehicle 12 is turned on or off. When the mounted electric equipment 30 is to be electrically disconnected from electrified vehicle 12 is when a failure of the mounted electric equipment 30 is detected through communication with the mounted ECU 38. As described above, the control ECU 24 is an example of the vehicle-side control unit in the present disclosure, and the first relay 22 is an example of the first switching unit in the present disclosure.

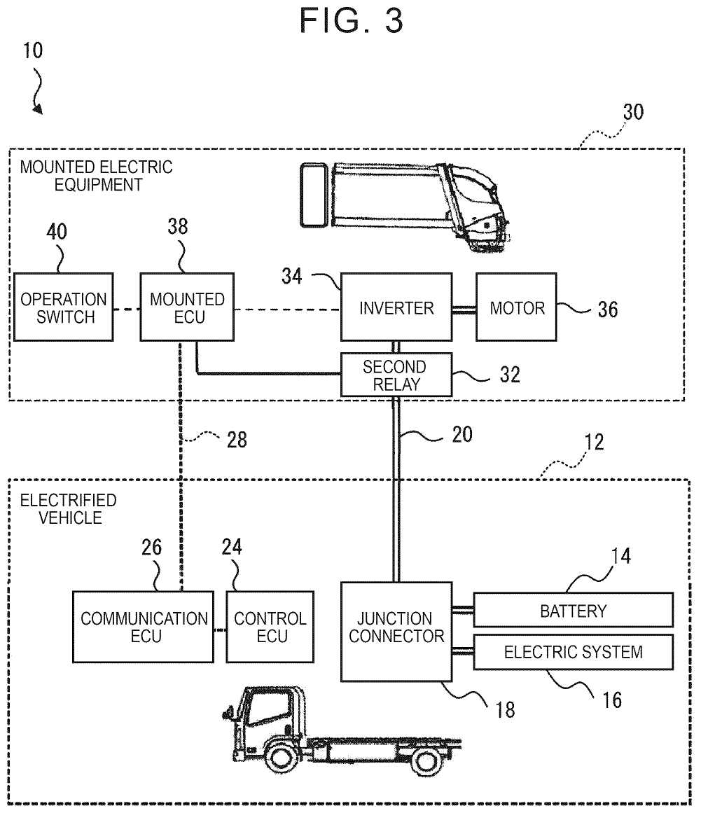

Next, the operation of the present embodiment will be described. FIG. 3 shows a configuration in which the first relay 22 is omitted from the specially equipped vehicle 10 according to the present embodiment as a comparative example of the present disclosure.

When the power switch of the electrified vehicle 12 is turned on, the power loads need to be electrically disconnected from the battery 14. This prevents the power loads (e.g., the inverter 34, the motor 36, etc.) connected to the battery 14 from being damaged by the electromotive force. Also, when the power switch of the electrified vehicle 12 is turned off, the power loads need to be electrically disconnected from the battery 14 in order to prevent the power loads from being damaged by the back electromotive force.

In the configuration of the comparative example shown in FIG. 3, in order to electrically disconnect the inverter 34 and the motor 36 of the mounted electric equipment 30 from the battery 14, the control ECU 24 and the mounted ECU 38 need to cooperate to perform the following communication and control.
(1) The control ECU 24 transmits a command for turning off the 2 relay 32 to the mounted ECU 38
(2) The mounted ECU 38 turns off the second relay 32
(3) The control ECU 24 is notified that the mounted ECU 38 has turned off the second relay 32.
(4) The control ECU 24 turns on or off the power of the electrified vehicle 12.

In order to cooperate the control ECU 24 and the mounted ECU 38 as described above, in developing the specially equipped vehicle 10, the development on electrified vehicle 12 side and the development on the mounted electric equipment 30 side need to be performed in cooperation with each other. Therefore, in the configuration of the comparative example shown in FIG. 3, there is a problem in that it takes time and effort to develop the specially equipped vehicle 10 and the development cost increases.

In the configuration of the comparative example shown in FIG. 3, when a failure occurs in the mounted electric equipment 30 and the second relay 32 cannot be turned off from the control ECU 24 side through the mounted ECU 38, the power supply (main relay) of electrified vehicle 12 cannot be turned on. This is because the traveling of electrified vehicle 12 may be adversely affected depending on the condition of the mounted electric equipment 30 during failure.

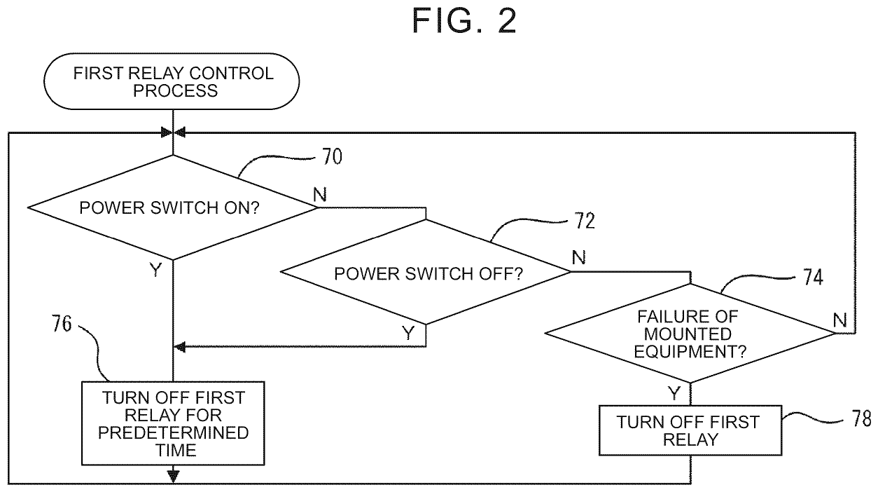

On the other hand, in the specially equipped vehicle 10 according to the present embodiment, the control ECU 24 constantly performs the first relay control process shown in FIG. 2. In step 70 of the first relay control process, the control ECU 24 determines whether power-on of the electrified vehicle 12 is instructed by turning on the power switch of the electrified vehicle 12. When No in step 70, the process proceeds to step 72. In step 72, the control ECU 24 determines whether power-off of electrified vehicle 12 is instructed by turning off the power switch of the electrified vehicle 12. When No in step 72, the process proceeds to step 74.

In step 74, the control ECU 24 communicates with the mounted ECU 38 through the communication ECU 26 and determines whether a failure has occurred in the mounted electric equipment 30, based on the result of the communication with the mounted ECU 38. When communication with the mounted ECU 38 is successfully performed, the process returns to step 70. As described above, steps 70 to 74 are repeated as long as all of the determination results in steps 70 to 74 are No.

When the power switch of the electrified vehicle 12 is turned on, the determination result in step 70 is Yes, and the process proceeds to step 76. In step 76, the control ECU 24 performs a process of turning off the first relay 22 for a predetermined time and turning on the power of electrified vehicle 12 while the first relay 22 is turned off (turning on the main relay to connect the battery 14 to the power supply line 20). Then, the process returns to step 70. Thus, it is possible to reduce, by a simple process of turning off the first relay 22 for a predetermined time, damage to the inverter 34 etc. of the mounted electric equipment 30 due to the electromotive force generated when the electrified vehicle 12 is powered on.

When the power switch of electrified vehicle 12 is turned off, the determination result in step 72 is Yes, and the process proceeds to step 76. In step 76, the control ECU 24 performs a process of turning off the first relay 22 for a predetermined time and turning off electrified vehicle 12 (turning off the main relay to electrically disconnect the battery 14 from the power supply line 20) while the first relay 22 is turned off. Accordingly, it is possible to reduce, by a simple process of turning off the first relay 22 for a predetermined time, reduce damage to the inverter 34 etc. of the mounted electric equipment 30 due to the back electromotive force generated when the electrified vehicle 12 is powered off.

In addition, there is a case where it is notified that a failure has occurred in the mounted electric equipment 30 through communication with the mounted ECU 38, or a case where it is not possible to communicate with the mounted ECU 38. In these cases, it can be determined that a failure such as a failure of the second relay 32, a system error, or a communication failure has occurred in the mounted electric equipment 30. In this case, the determination result in step 74 is Yes, the process proceeds to step 78. In step 78, the control ECU 24 turns off the first relay 22 to electrically disconnect the mounted electric equipment 30 from the electrified vehicle 12, and returns to step 70. Accordingly, even when a failure occurs in the mounted electric equipment 30, electrified vehicle 12 (specially equipped vehicle 10) can travel on its own.

As described above, in the specially equipped vehicle 10 according to the present embodiment, the first relay 22 is provided on the electrified vehicle 12 side of the power supply line 20 connecting the battery 14 installed in the electrified vehicle 12 and the power loads (inverter 34 and motor 36) provided in the mounted electric equipment 30 mounted on the electrified vehicle 12. In addition, the second relay 32 is provided on the mounted electric equipment 30 side of the power supply line 20. The mounted ECU 38 provided in the mounted electric equipment 30 turns on and off the second relay 32 in response to the operation of the operation switch 40 of the mounted electric equipment 30. When the mounted electric equipment 30 is to be electrically disconnected from electrified vehicle 12, the control ECU 24 provided in electrified vehicle 12 turns off the first relay 22. As a result, the mounted electric equipment 30 can be electrically disconnected from electrified vehicle 12, when needed, by using a simple configuration. Therefore, it is possible to reduce the cost of developing the control ECU 24 and the program to be installed in the mounted ECU 38.

Further, in the present embodiment, when the mounted electric equipment 30 is to be electrically disconnected from electrified vehicle 12, the power switch of the electrified vehicle 12 is turned on or off. Accordingly, it is possible to reduce damage to the mounted electric equipment 30 when the power switch of electrified vehicle 12 is turned on or off.

In the present embodiment, when the mounted electric equipment 30 is to be electrically disconnected from electrified vehicle 12 is when the control ECU 24 detects a failure of the mounted electric equipment 30 through communication with the mounted ECU 38. Accordingly, even when a failure occurs in the mounted electric equipment 30, the power switch of the electrified vehicle 12 can be turned on to cause the specially equipped vehicle 10 to travel.

In the above embodiment, the first relay 22 is used as the first switching unit, and the second relay 32 is used as the second switching unit. However, the present disclosure is not limited to this, and semiconductor switching elements etc. may be used as the first switching unit and the second switching unit.

What is claimed is:

1. A specially equipped vehicle comprising:
a first switching unit provided on a vehicle side of a power supply circuit, the power supply circuit connecting a battery installed in the vehicle and a power load provided in mounted equipment mounted on the vehicle;
a second switching unit provided on a mounted equipment side of the power supply circuit;
a mounted equipment-side control unit provided in the mounted equipment, the mounted equipment-side control unit being configured to turn on or off the second switching unit in response to an operation of a switch of the mounted equipment; and
a vehicle-side control unit provided in the vehicle, the vehicle-side control unit being configured to turn off the first switching unit when the mounted equipment is to be electrically disconnected from the vehicle.

2. The specially equipped vehicle according to claim 1, wherein when the mounted equipment is to be electrically disconnected from the vehicle is when a power switch of the vehicle is turned on or off.

3. The specially equipped vehicle according to claim 1, wherein when the mounted equipment is to be electrically disconnected from the vehicle is when the vehicle-side control unit detects a failure of the mounted equipment through communication with the mounted equipment-side control unit.
